(19) United States
(12) Patent Application Publication
(10) Pub. No.: US 2008/0261130 A1
(43) Pub. Date: Oct. 23, 2008

(54) Process for a Thermal Transfer of a Liquid Crystal Film Using a Transfer Element

(76) Inventors: Robert Hammond-Smith, Fordinbridge (GB); Sylke Klein, Rossdorf (DE); Philip Edward May, Sidcup (GB)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/094,509

(22) PCT Filed: Nov. 2, 2006
(86) PCT No.: PCT/EP2006/010500

§ 371 Date: May 21, 2008

(30) Foreign Application Priority Data
Nov. 22, 2005 (EP) 05025383.0

(51) Int. Cl. B41M 5/36

(52) U.S. Cl. 430/20

(57) ABSTRACT

The invention relates to a laser-induced process that employs a transfer element comprising a liquid crystal material for a thermal transfer onto a receiving surface. The process is suitable for generating markings with various appearance or optical effects on a surface of choice. The transfer element comprises a light-to-heat conversion layer and a transfer layer The transfer layer comprises a liquid crystal material, especially a liquid crystal polymer film.

### FIELD OF THE INVENTION

The invention relates to a laser-induced process that employs a transfer element comprising a liquid crystal material for a thermal transfer onto a receiving surface. The process is suitable for generating markings with various appearance or optical effects on a surface of choice.

The transfer element comprises a light-to-heat conversion layer and a transfer layer. The transfer layer comprises a liquid crystal material, especially a liquid crystal polymer film.

### BACKGROUND AND PRIOR ART

The use of liquid crystal polymer films as security devices has been reported in prior art. EP 0 435 029 discloses a data carrier with an optically variable security element that contains an oriented liquid crystal polymer. U.S. Pat. No. 5,678,863 (corresponding to GB 2,268,906) discloses a security marking for a document of value comprising a watermark coated with a cholesteric liquid crystal material producing optical effects which differ when viewed in transmitted and reflected light. The cholesteric liquid crystal material is for example a liquid crystal polymer.

A laser-induced transfer process for generating a coloured printing is described in WO 95/13195.

Polymerisable liquid crystal materials are known in prior art for the preparation of anisotropic polymer films with uniform orientation. These films are usually prepared by coating a thin layer of a polymerisable liquid crystal mixture onto a substrate, aligning the mixture into uniform orientation and polymerizing the mixture.

One aim of the present invention is to provide a marking, in particular for decorative and security applications, that is easy to manufacture and can be applied to a broad variety of substrates, surfaces and objects.

The inventors of the present invention have found that the above aims can be fulfilled by making a marking comprising a liquid crystal structure by a thermal transfer process. The process makes use of a new transfer element comprising a liquid crystal transfer layer.

The optically variable marking of the present invention is easy to manufacture, as will be shown below.

Another advantage of the optically variable marking of the present invention compared to prior art devices is that the transfer element can be made ready for use in one roll to roll process involving coating, laminating, curing and rewinding.

### Definition of Terms

The term ‘light-to-heat conversion layer’ as used for this invention means a layer within a flat element, that is capable of absorbing radiation and converting it to heat. The conversion layer may consist of a thin layer on top of or between other layers. It may as well be at the same time the backing layer or the substrate of the transfer element.

The term ‘transfer layer’ as used for this invention means the layer which is transferred in part or completely by the transfer process. The transferred portion usually makes up at least part of the ‘marking’ or it defines the outline of the marking.

The term ‘thermal transfer’ as used for this invention means the process of transferring matter from a substrate to a receiving object by way of applying heat or radiation to the substrate. The term ‘laser-induced transfer’ is used in the same meaning as thermal transfer, when a laser or laser-generated heat is employed for this process.

Polymerisable compounds with one polymerisable group are also referred to as “monoreactive” compounds, compounds with two polymerisable groups as “direactive” compounds, and compounds with more than two polymerisable groups as “multireactive” compounds. Compounds without a polymerisable group are also referred to as “non-reactive” compounds.

The term “reactive mesogen” (RM) means a polymerisable mesogenic or liquid crystal compound.

The term ‘film’ as used in this application includes self-supporting, i.e. free-standing, films that show more or less pronounced mechanical stability and flexibility, as well as coatings or layers on a supporting substrate or between two substrates.

The term ‘marking’ is generally used for the product of a marking process, that changes parts or the whole surface of an object of choice. In this application markings especially mean the matter transferred onto a surface in a controlled manner. The term ‘marking’ includes films or layers covering the entire area of a surface, as well as markings covering discrete regions of a surface for example in the shape of a pattern or image.

The term ‘liquid crystal or mesogenic material’ or ‘liquid crystal or mesogenic compound’ should denote materials or compounds comprising to a certain percentage one or more rod-shaped, board-shaped or disk-shaped mesogenic groups, i.e. groups with the ability to induce liquid crystal phase behaviour. Liquid crystal compounds with rod-shaped or board-shaped groups are also known in the art as ‘calamitic’ liquid crystals. Liquid crystal compounds with a disk-shaped group are also known in the art as ‘discotic’ liquid crystals. The compounds or materials comprising mesogenic groups do not necessarily have to exhibit a liquid crystal phase themselves. It is also possible that they show liquid crystal phase behaviour only in mixtures with other compounds, or when the mesogenic compounds or materials, or the mixtures thereof, are polymerised.

For the sake of simplicity, the term ‘liquid crystal material’ or ‘LC material’ is used hereinafter for both liquid crystal materials and mesogenic materials, and the term ‘mesogen’ is used for the mesogenic groups of the material.

The director means the preferred orientation direction of the long molecular axes (in case of calamitic compounds) or short molecular axis (in case of discotic compounds) of the mesogens in a liquid crystal material.

The term ‘planar structure’ or ‘planar orientation’ refers to a layer or film of liquid crystal material wherein the director is substantially parallel to the plane of the film or layer.

The term ‘resin’ refers to solid, semisolid, or pseudosolid organic materials that have an indefinite and often high relative molecular mass, and generally soften or melt over a range of temperatures on heating. The term is further defined in ISO 4618-3:1984 “Paints and varnishes—Vocabulary—Part 3: Terminology of resins” and in “Ullmann's Encyclopedia of Industrial Chemistry”, Vol. A23, VCH (1995), 89-108.

The term ‘radiation’ refers to electromagnetic radiation, including microwave, infrared, visible and ultraviolet radiation (cm to nm wavelengths).

### SUMMARY OF THE INVENTION

The invention relates to a process that employs a transfer element comprising a liquid crystal material for a thermal transfer onto a receiving surface. Preferably the thermal transfer is laser-induced. The process is suitable for generating markings with various appearance or optical effects on a surface of choice.

The invention further relates to a transfer element used in the process, especially in a laser-induced process. The element comprises at least a light-to-heat conversion layer and a transfer layer. The transfer layer comprises a liquid crystal material, especially a liquid crystal polymer film.

The invention further relates to a liquid crystal polymer film used as the liquid crystal material of the transfer element. A method and a composition for preparing such films are further aspects of the invention.

The invention finally relates to markings applied to surfaces prepared by the transfer process according to the invention. The markings have various appearance or optical effects. They can also be invisible to the naked eye.

The invention further relates to a security marking, thread or device, hot stamping foil or watermark, in particular for the purpose of prevention of counterfeiting, authentification, verification, or identification of data or information, comprising a marking according to the invention.

The invention further relates to a data carrier or document of value comprising a marking prepared according to the invention.

### DESCRIPTION OF THE DRAWINGS

FIG. 1 shows a transfer element comprising a transfer layer (1) and a light-to-heat conversion layer (2), that functions as a supporting substrate or backing layer at the same time.

FIG. 2 shows a second embodiment of the transfer element comprising a transfer layer (1), a light-to-heat conversion layer (2) having no structural strength on its own, and a separate substrate (3)to support the element. The substrate (3) in this element is preferably translucent for the radiation employed in the process.

Other optional layers are omitted for clarity in the diagrams. The thickness of the layers can vary.

FIG. 3 shows two stages of the marking process. On the left hand side a transfer element according to FIG. 1 is placed in contact with a surface (4). A laser beam (5) is projected from the vertical direction onto the element. On the right hand side the provided marking (1″) on the surface is revealed after removal of the element. The marking (1″) is part of the former transfer layer (1) and it is situated where the laser has hit the transfer element.

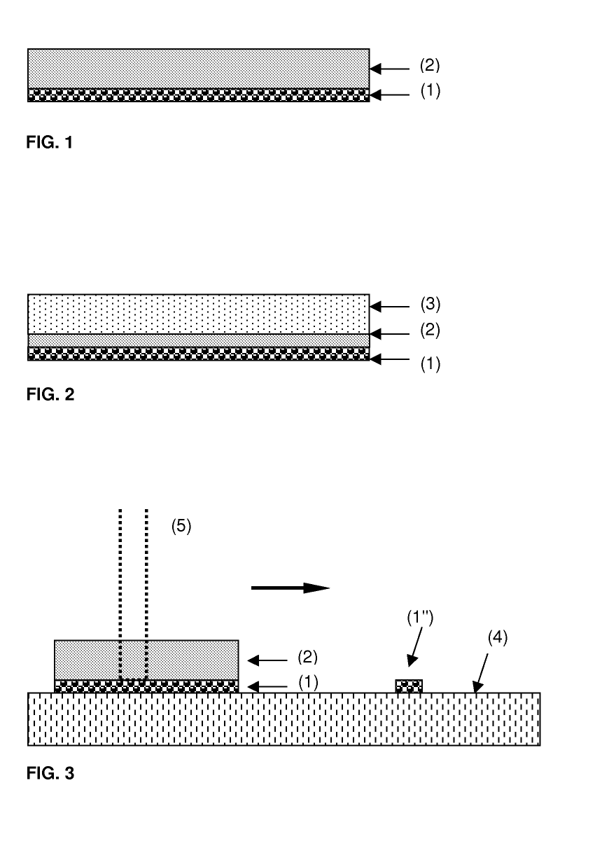

### DETAILED DESCRIPTION OF THE INVENTION

A first embodiment of the invention relates to a process for thermal transfer of a liquid crystal (LC) material onto a receiving surface. The process is most suitable for generating a marking on the surface of choice. The LC material is preferably present as a film, most preferably as a film supported by a substrate. The substrate and the LC material essentially make up the transfer element. During the transfer process the LC material is transferred from the substrate onto the receiving surface by means of heat or radiation, preferably by a laser beam. During this operation the transfer element and the receiving surface are positioned closely on top of each other. Preferably there is no gap between both parts. This can be achieved by placing the element onto the surface, or even by applying slight mechanical pressure, gas pressure or vacuum techniques. After employing the radiation the transfer is completed by removal of the substrate, which may still carry a part of the transfer layer, mostly in areas where no thermal transfer was induced. By selectively applying heat or radiation in certain areas of the transfer element any patterned shape of the transferred matter can be achieved. In this way a marking of defined shape is produced on the receiving surface. The marking is generated preferably by lasermarking, for example with a Nd:YVO₄-laser, a Nd:YAG-laser, a CO₂-laser or an excimer-laser with varying wavelengths. Any laser equipment capable of generating heat in the place where it hits a suitable material should be of use for the invention.

The nature of the markings can vary. They can be invisible to the naked eye under certain conditions. If the marking is used as a hidden marking, it usually can be made visible by means of polarised light or by means of a polarising filter. If the marking is used as a visible marking, the effect is made visible by a suitable background or an additional layer on top of the layer of the marking. Some markings are visible by themselves on ordinary backgrounds. Most useful backgrounds are black, white, transparent, reflecting or luminescent surfaces, depending on the nature of the LC polymer film and further components. All known optical effects that can be achieved with solid or semi-solid liquid crystal layers can be used for the markings.

In most cases the heat or laser will be applied from one side of the transfer element, while the transfer layer is on its opposite side. Only when a translucent object is being marked, the laser can also be employed from the side of the transfer layer.

Preferably heat or radiation applied to the transfer element is of short duration. This is preferably achieved by irradiation with a quickly moving laser beam of high energy or it is achieved by a short interval of irradiation with any other radiation source. Most preferably a continuous or pulsed laser that scannes the desired part of the transfer element is employed. The energy employed for the transfer is limited in such a way that the transferred LC material is not substantially damaged in its structure, but it is chosen strong enough to effectively transfer portions of the transfer layer.

Surprisingly it has been found that the energy doses of the radiation or heat can be adjusted, so that transfer of the transfer layer is sufficiently achieved, while unwanted alteration of the transferred matter and the receiving surface are avoided. Several wavelengths of lasers, pulsed or continuous, can be used.

The transfer element should be designed in such a way, that it can absorb at least a part of the radiation. For that reason, the transfer element comprises a light-to-heat conversion layer. The conversion layer can be present as a distinct layer or be incorporated into a multifunctional layer. In one embodiment of the invention the transfer layer is the substrate of the transfer element itself. This is the most simple form, where the substrate makes up the carrying part of the element and at the same time has the function of absorbing the laser light. When the substrate has the function of a light-to-heat conversion layer it is chosen so it can absorb the radiation used for forming the markings. The absorbing substrate should not be transparent for the wavelength of the laser. Suitable substrates for this purpose are normally opaque, semi-opaque, coloured or pigmented substrates. The absorbing material should be adjusted with its absorbing wavelength to the wavelength of the source of radiation employed for the process. Suitable dyes and pigments as absorbers are known to the expert and can be chosen from a broad variety of available products, but absorbers well suited for the use in laser writing are explicitly mentioned here. An example for a substrate which serves as a light-to-heat conversion layer is a black polyethylene film which absorbs most of the commercially available laser sources. Useful films will be thick enough to be handled and thin enough to effect a transfer in the process. Such films are commonly known from e.g. household use and they are pigmented with carbon black, which is an excellent absorber for the employed lasers. Preferably the thickness of such a supporting film is from 15 to 200 micrometers (μm), more preferably form 20 to 80 micrometers.

Apart from the parameters of the radiation, the design of the transfer element is a critical part of the process. Therefore a second embodiment of the invention relates to a transfer element used as a means for the process. One prerequisite for the element is that the transfer layer is thin in order to achieve markings with even small details. So radiation employed on the light-to-heat conversion layer will lead to accurate patterns on the front side. If the substrate is transparent to the laser and a separate light-to-heat conversion layer is present (FIG. 2), then the thickness of the substrate will not contribute to the effective thickness of the transfer element. This way even more rigid substrates can be employed in the process without diminishing the high resolution. As a rule of thumb, the highest possible resolution of patterns provided by the process is likely to be in the order of magnitude of the thickness of the transfer layer. Preferably the thickness of the transfer layer is in the range of 0.1 to 20 micrometers (μm).

Preferably the thermal transfer is laser-induced, but any known radiation source in the range of IR, visible or UV light may equally be employed.

The substrate can be a thin sheet of plastic, glass, metal, paper or any other material that is available as sheets. Preferably the substrate is flexible, and available in any thickness. Plastic and metal substrates are preferred.

The transfer layer and the light-to-heat conversion layer are generally in close contact to each other in the transfer element, or they are separated only by one or two thin layers, e.g. an interlayer, that enable a rapid transfer of heat from the conversion layer to the transfer layer. An interlayer may be situated between the functional layers of the element, e.g. in order to ease the separation of the transfer layer from the remaining element. The interlayer may also be of use in the process of making the transfer element to induce or improve orientation of the material used for building the transfer layer. It may also insulate the transfer layer against extreme temperatures generated in the light-to heat conversion layer. The interlayers may be transferred together with the transfer layer, or stay on the element. Preferably there is no interlayer between the transfer layer, and the light-to heat conversion layer and any of the functions of the interlayer are fulfilled by the functional layers themselves. Functions of the interlayer can be to ease the separation of the transfer layer from the remaining element, to help in the production of the transfer element, to help aligning the LC material in the transfer layer, to shield the transfer layer from excessive heat generated in the conversion layer or to shield the transfer layer or the marked surface form radiation employed in the transfer process. The optional interlayer may also prevent any transfer of coloured material of the light-to-heat conversion layer onto the marking or the marked surface.

One improvement of the invention is that the transferred material is a liquid crystalline material. The produced marking thus shows properties inherent to liquid crystal materials like those of optical nature which are suitably used for various applications. For example the transferred film can filter polarized light or selectively reflect light of certain wavelengths and states of polarisation. The effects may vary by the angular direction of viewing the marking, by temperature or by further polarising filters used for viewing the marking.

A further improvement is that the liquid crystalline properties of the transferred material are essentially not damaged by the thermal process. The process prevents permanent loss of the ability to adopt a liquid crystalline phase by the material, because thermal stress on the material is surprisingly low. Also, the produced marking needs no further production steps once it is transferred onto a surface, since it is already polymerised and solid.

Finally it is possible to form markings by various size and shape, even with sizes in the micrometer range. The process is capable of generating structures like pictures, writing or whole surfaces covered with the transfer film. The laser-induced transfer process is more accurate, cleaner and faster compared to conventional printing methods. In contrast to a printing mask the shape of markings prepared in consecutive processes can be changed instantly inbetween the processes without changing any parts of the production assembly. Only the path of the laser or the heat source has to be remodulated to a different path.

The invention further relates to the use of a marking as described above and below in optical elements, decorative or security applications. Further, the markings can be used as aligning layers for any further LC material placed on top of the markings.

The invention further relates to a security marking, thread or device, hologram, hot stamping foil or watermark, in particular for the purpose of prevention of counterfeiting, for authentification, verification, or identification of data or information, comprising an optically variable marking as described above and below.

The invention further relates to a data carrier or document of value comprising a marking, thread, device, hologram, hot stamping foil or watermark as described above.

The LC material employed in the process and as part of the transfer element and of the markings will for example have a nematic or cholesteric phase at room temperature, although the material can have any other liquid crystalline phase or be optically isotropic.

In a special embodiment of the present invention the LC film or the transfer layer comprises a cholesteric liquid crystal (CLC) material. A CLC material in the cholesteric phase exhibits a helically twisted molecular structure. In a layer of CLC material that is macroscopically aligned into planar orientation, i.e. wherein the helix axis is perpendicular to the plane of the layer, incident light interacts with the helically twisted structure of the CLC material. As a result the CLC layer shows selective reflection of 50% of the intensity of incident light of a specific wavelength as circularly polarized light having the same handedness as the cholesteric helix. The remaining 50% are transmitted as circularly polarized light having opposite handedness. Thus, when viewed against a dark or black substrate the reflection colour of a CLC material is clearly visible on a dark background, whereas when viewed in transmission the CLC material is transparent and the reflection property is perceptible mainly as a pattern of interference colours under altering viewing angles. Furthermore, viewing the material against a dark background with the correct circular polarizer (dependent upon the chirality of the cholesteric material used) will make the liquid crystal polymer film invisible.

The central wavelength of reflection λ depends on the pitch p and the average refractive index n of the CLC material according to the equation

λ=n·p.

The effective helical pitch of the CLC layer that interacts with incident light and thereby the wavelength of the reflected light are varying depending on the viewing angle. This results in a shift of the reflection colour of the CLC layer to shorter wavelengths when being viewed at increasing angles from normal. Preferably the CLC material reflects light in the visible wavelength range. The CLC material may also be selected such that it reflects a broad wavelength band or the entire visible spectrum, so that no specific reflection colour is seen in direct view, but can be made visible by observation through a circular polariser. Broad waveband CLC films or coatings and their preparation are described e.g. in EP 0 606 940, WO 97/35219, EP 0 982 605 and WO 99/02340.

In another special embodiment of the present invention the LC film or the transfer layer comprises a nematic liquid crystal material. The nematic film of the transfer element and of the markings can be uniformly aligned or split in domains of different directions of the alignment. In any case, when the marking is positioned on a reflecting surface it can be made clearly visible by viewing through a linear or circular polariser.

A polariser can be used as a viewing aid or it is present as part of the marking itself as an additional film close to the marking, so it can be viewed with the naked eye.

Suitable substrates to be marked by the process according to the present invention include films, paper, board, leather, cellulose sheeting, textiles, plastics, glass, ceramics and metals. Suitable plastics are polymer films of for example polyester, polyethylene terephthalate (PET), polyvinyl alcohol (PVA), polycarbonate (PC) or di- or triacetyl cellulose (TAC).

The LC material of the transfer layer preferably comprises a polymer LC material. This is produced by polymerising a mixture comprising polymerisable material, which is described more closely in the following section.

The polymerisable LC material is preferably a mixture of two or more compounds, at least one of which is a polymerisable or crosslinkable compound. Polymerisable compounds with one polymerisable group are hereinafter also referred to here as “monoreactive”. Crosslinkable compounds, i.e. having two or more polymerisable groups, are also referred to here as “di- or multireactive”.

The polymerisable LC material preferably comprises at least one monoreactive compound and at least one di- or multireactive compound.

The polymerisable mesogenic or LC compounds are preferably monomers, very preferably calamitic monomers. These materials typically have good optical properties, like reduced chromaticity, and can be easily and quickly aligned into the desired orientation, which is especially important for the industrial production of polymer films at large scale. It is also possible that the polymerisable material comprises one or more discotic monomers.

The compositions comprising polymerisable materials as described above and below are another aspect of the invention.

Unless stated otherwise, the percentages of components of a polymerisable mixture as given above and below refer to the total amount of solids in the mixture, i.e. not including solvents.

The compositions usually comprise 5 to 95% of monoreactive and 10 to 95% of di- or multireactive mesogens. In absence of other polymerisable compounds, the composition preferably comprises 10% or more to 80% or less, most preferably 15% or more to 45% or less of monoreactive mesogens. Further, the composition preferably comprises 10% or more to 90% or less, most preferably 25% or more to 80% or less, of di- or multireactive mesogens. The composition preferably comprises 20% or more to 40% or less of monoreactive mesogens together with 50% or more to 70% or less of di- or multireactive mesogens.

Polymerisable mesogenic mono-, di- and multireactive compounds suitable for the present invention can be prepared by methods which are known per se and which are described in standard works of organic chemistry like for example Houben-Weyl, Methoden der organischen Chemie, Thieme-Verlag, Stuttgart.

Suitable polymerisable mesogenic or LC compounds for use as monomer or comonomer in a polymerisable LC mixture are disclosed for example in WO 93/22397, EP 0 261 712, DE 195 04 224, WO 95/22586, WO 97/00600, U.S. Pat. No. 5,518,652, U.S. Pat. No. 5,750,051, U.S. Pat. No. 5,770,107 and U.S. Pat. No. 6,514,578.

Examples of suitable and preferred polymerisable mesogenic or LC compounds (reactive mesogens) are shown in the following list.

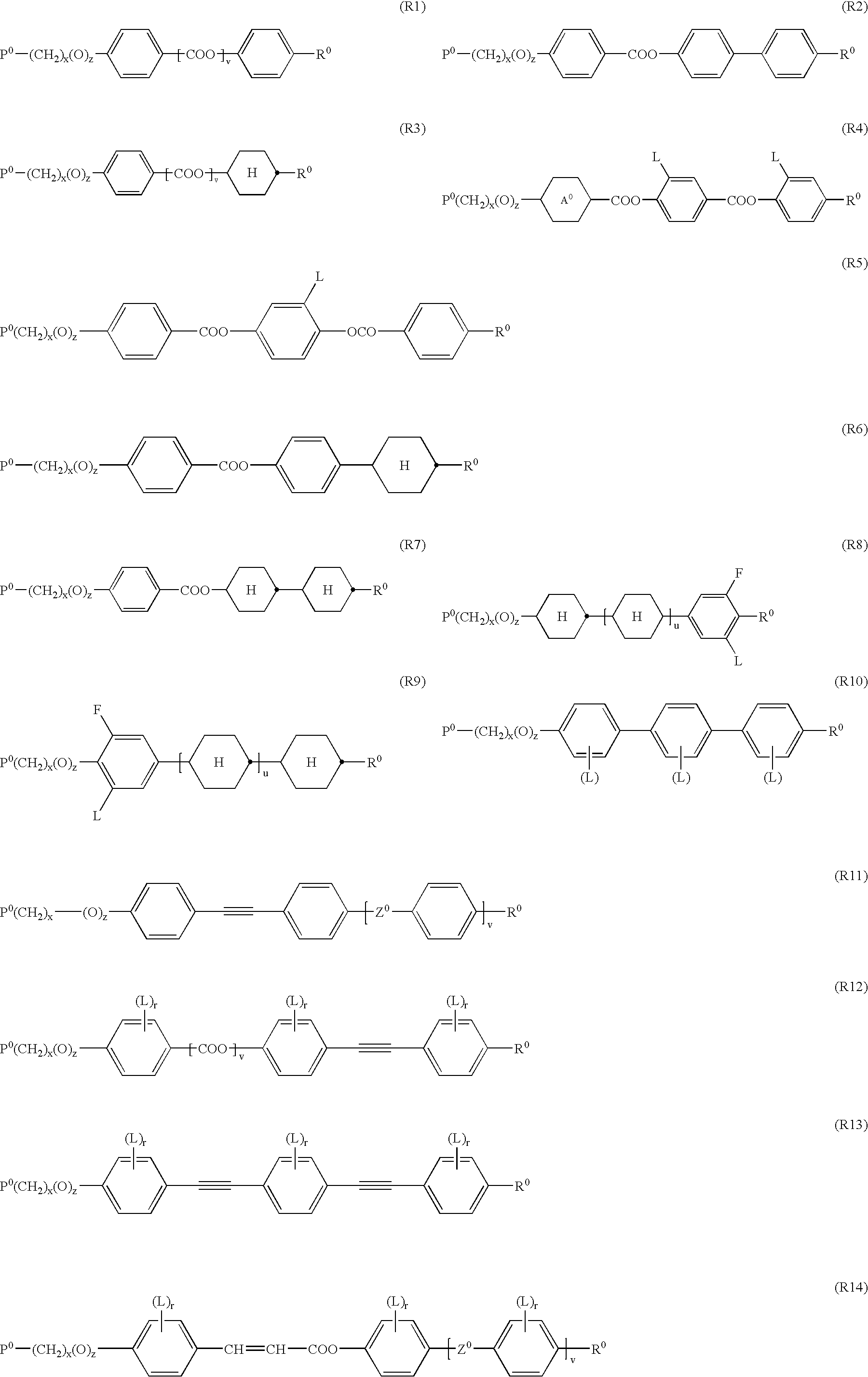

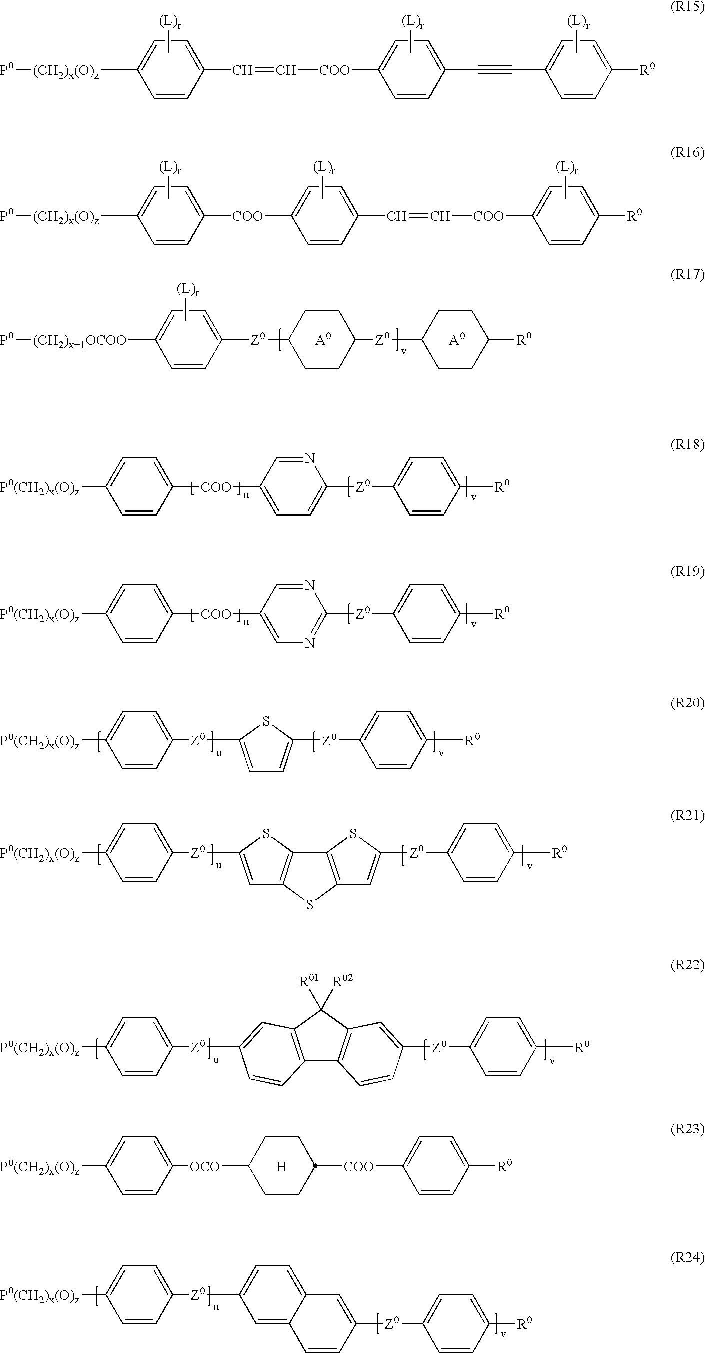

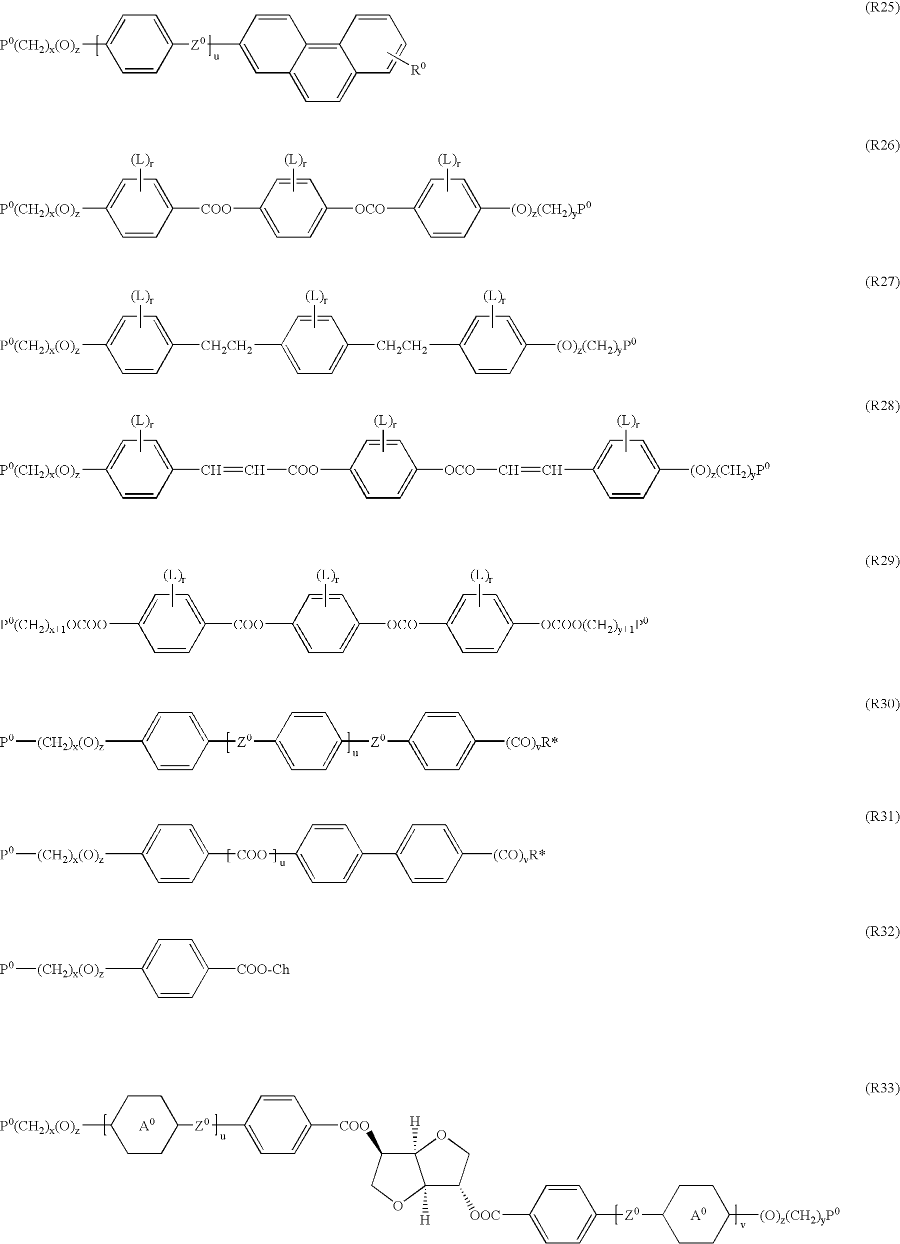

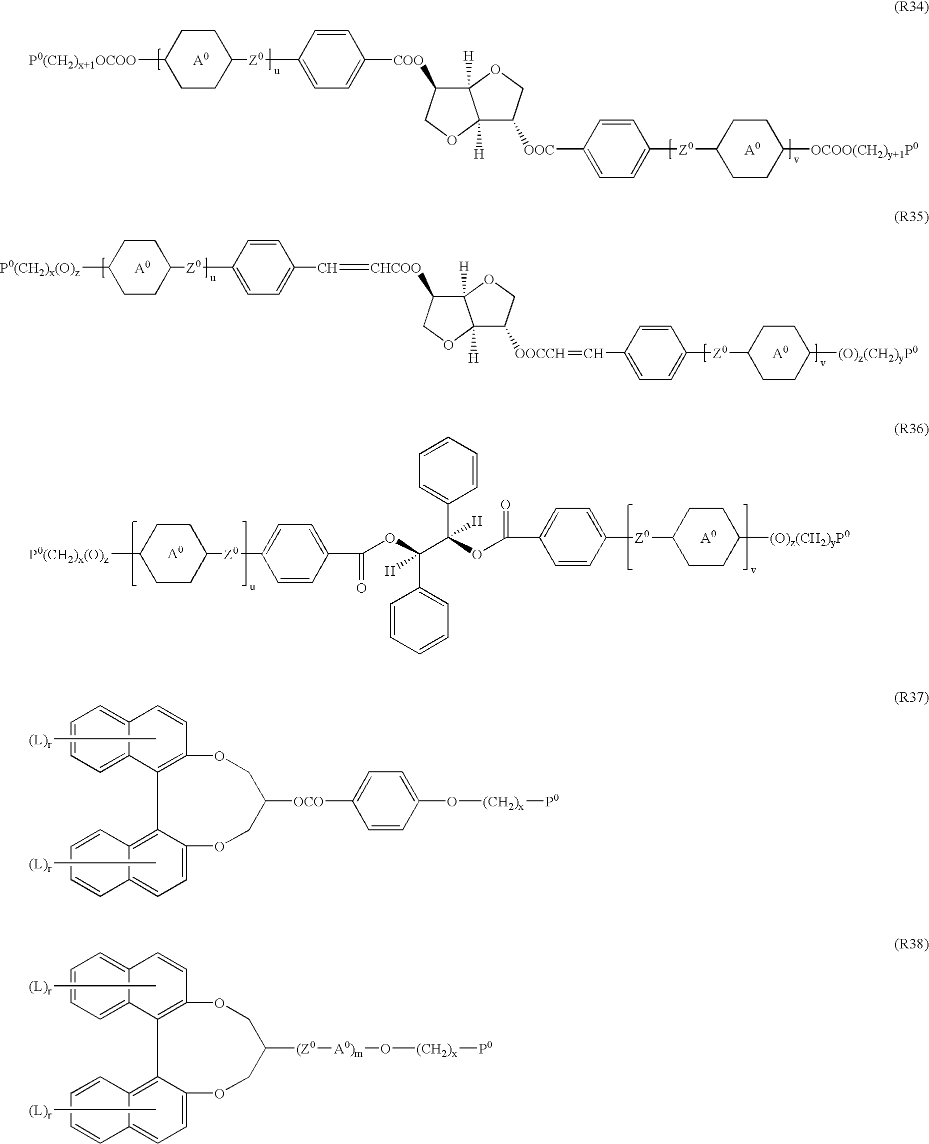

wherein
P⁰ is, in case of multiple occurrence independently of one another, a polymerisable group, preferably an acryl, methacryl, oxetane, epoxy, vinyl, vinyloxy, propenyl ether or styrene group,
r is 0, 1, 2, 3 or 4,
x and y are independently of each other 0 or identical or different integers from 1 to 12,
z is 0 or 1, with z being 0 if the adjacent x or y is 0,
A⁰ is, in case of multiple occurrence independently of one another, 1,4-phenylene that is optionally substituted with 1, 2, 3 or 4 groups L, or trans-1,4-cyclohexylene,

u and v are independently of each other 0 or 1,
Z⁰ is, in case of multiple occurrence independently of one another, —COO—, —OCO—, —CH₂CH₂—, —C≡C—, —CH═CH—, —CH═CH—COO—, —OCO—CH═CH— or a single bond,
R⁰ is alkyl, alkoxy, thioalkyl, alkylcarbonyl, alkoxycarbonyl, alkylcarbonyloxy or alkoxycarbonyloxy with 1 or more, preferably 1 to 15 C atoms which is optionally fluorinated, or is Y⁰ or P—(CH₂)_{y}—(O)_{z}—,
Y⁰ is F, Cl, CN, NO₂, OCH₃, OCN, SCN, SF₅, optionally fluorinated alkylcarbonyl, alkoxycarbonyl, alkylcarbonyloxy or alkoxycarbonyloxy with 1 to 4 C atoms, or mono- oligo- or polyfluorinated alkyl or alkoxy with 1 to 4 C atoms,
R^{01,02} are independently of each other H, R⁰ or Y⁰,
R* is a chiral alkyl or alkoxy group with 4 or more, preferably 4 to 12 C atoms, like 2-methylbutyl, 2-methyloctyl, 2-methylbutoxy or 2-methyloctoxy,
Ch is a chiral group selected from cholesteryl, estradiol, or terpenoid radicals like menthyl or citronellyl,
L is, in case of multiple occurrence independently of one another, H, F, Cl, CN or optionally halogenated alkyl, alkoxy, alkylcarbonyl, alkoxycarbonyl, alkylcarbonyloxy or alkoxycarbonyloxy with 1 to 5 C atoms,

and wherein the benzene rings can additionally be substituted with one or more identical or different groups L.

Suitable unpolymerisable chiral compounds are for example standard chiral dopants like R- or S-811, R- or S-1011, R- or S-2011, R- or S-3011, R- or S-4011, R- or S-501 1, or CB 15 (all available from Merck KGaA, Darmstadt, Germany).

Suitable polymerisable chiral compounds are for example those listed above, or the polymerisable chiral material Paliocolor® LC756 (from BASF AG, Ludwigshafen, Germany).

Very preferred are chiral compounds with a high helical twisting power (HTP), in particular compounds comprising a sorbitol group as described for example in WO 98/00428, compounds comprising a hydrobenzoin group as described for example in GB 2,328,207, chiral binaphthyl derivatives as described for example in WO 02/94805, chiral binaphthol acetal derivatives as described for example in WO 02/34739, chiral TADDOL derivatives as described for example in WO 02/06265, and chiral compounds having at least one fluorinated linkage group and a terminal or central chiral group as described for example in WO 02/06196 or WO 02/06195.

Unless stated otherwise, the general preparation of polymer LC films according to this invention can be carried out according to standard methods known from the literature. Typically a polymerisable LC material is coated or otherwise applied onto a substrate where it aligns into uniform orientation, and polymerized in situ in its LC phase at a selected temperature for example by exposure to heat or actinic radiation, preferably by photo-polymerisation, very preferably by UV-photopolymerisation, to fix the alignment of the LC molecules. If necessary, uniform alignment can promoted by additional means like shearing or annealing the LC material, surface treatment of the substrate, or adding surfactants to the LC material.

As substrates for example metal foil or plastic film can be used. It is also possible to put a second substrate on top of the coated material prior to, during and/or after polymerisation. The original substrate can then be removed after polymerisation and is replaced by the second substrate. When using two substrates in case of curing by actinic radiation, at least one substrate has to be transmissive for the actinic radiation used for the polymerisation.

Suitable substrates are for example films of polyethylene, polypropylene, polyester, polyethyleneterephthalate (PET), polyethylenenaphthalate (PEN), cellulose acetate, known copolymers of the aforementioned polymers, aluminium and metallised polymer films.

The polymerisable material can be applied onto the substrate by conventional coating techniques like spin-coating, bar or blade coating.

It is also possible to dissolve the polymerisable material in a suitable solvent. This solution is then coated or printed onto the substrate, for example by spin-coating or other known techniques, and the solvent is evaporated off before polymerisation. In many cases it is suitable to heat the mixture in order to facilitate the evaporation of the solvent. As solvents for example standard organic solvents can be used. The solvents can be selected for example from ketones such as acetone, methyl ethyl ketone, methyl propyl ketone or cyclohexanone; esters such as methyl, ethyl or butyl acetate or methyl acetoacetate; alcohols such as methanol, ethanol or isopropyl alcohol; aromatic solvents such as toluene or xylene; halogenated hydrocarbons such as di- or trichloromethane; glycols or their esters such as PGMEA (propyl glycol monomethyl ether acetate), γ-butyrolactone, and the like. It is also possible to use binary, ternary or higher mixtures of the above solvents.

Initial alignment (e.g. planar alignment) of the polymerisable LC material can be achieved for example by rubbing treatment of the substrate, by shearing the material during or after coating, by annealing the material before polymerisation, by application of an alignment layer, by applying a magnetic or electric field to the coated material, or by the addition of surface-active compounds to the material. Reviews of alignment techniques are given for example by I. Sage in “Thermotropic Liquid Crystals”, edited by G. W. Gray, John Wiley & Sons, 1987, pages 75-77; and by T. Uchida and H. Seki in “Liquid Crystals—Applications and Uses Vol. 3”, edited by B. Bahadur, World Scientific Publishing, Singapore 1992, pages 1-63. A review of alignment materials and techniques is given by J. Cognard, Mol. Cryst. Liq. Cryst. 78, Supplement 1 (1981), pages 1-77.

Especially preferred is a polymerisable material comprising one or more surfactants that promote a specific surface alignment of the LC molecules. Suitable surfactants are described for example in J. Cognard, Mol. Cryst. Liq. Cryst. 78, Supplement 1,1-77 (1981). Preferred aligning agents for planar alignment are for example non-ionic surfactants, preferably fluorocarbon surfactants such as the commercially available Fluorad FC-171® (from 3M Co.) or Zonyl FSN®) (from DuPont), multiblock surfactants as described in GB 2 383 040 or polymerisable surfactants as described in EP 1 256 617.

It is also possible to apply an alignment layer onto the substrate and provide the polymerisable material onto this alignment layer. Suitable alignment layers are known in the art, like for example rubbed polyimide or alignment layers prepared by photoalignment as described in U.S. Pat. No. 5,602,661, U.S. Pat. No. 5,389,698 or U.S. Pat. No. 6,717,644.

It is also possible to induce or improve alignment by annealing the polymerisable LC material at elevated temperature, preferably at its polymerisation temperature, prior to polymerisation.

Polymerisation is achieved for example by exposing the polymerisable material to heat or actinic radiation. Actinic radiation means irradiation with light, like UV light, IR light or visible light, irradiation with X-rays or gamma rays or irradiation with high energy particles, such as ions or electrons. Preferably polymerisation is carried out by UV irradiation. As a source for actinic radiation for example a single UV lamp or a set of UV lamps can be used. When using a high lamp power the curing time can be reduced.

Polymerisation is preferably carried out in the presence of an initiator absorbing at the wavelength of the actinic radiation. For example, when polymerizing by means of UV light, a photoinitiator can be used that decomposes under UV irradiation to produce free radicals or ions that start the polymerisation reaction. For polymerizing acrylate or methacrylate groups preferably a radical photoinitiator is used. For polymerizing vinyl, epoxide or oxetane groups preferably a cationic photoinitiator is used. It is also possible to use a thermal polymerisation initiator that decomposes when heated to produce free radicals or ions that start the polymerisation. Typical radicalic photoinitiators are for example the commercially available Irgacure® or Darocure® (Ciba Geigy AG, Basel, Switzerland). A typical cationic photoinitiator is for example UVI 6974 (Union Carbide).

The polymerisable material may also comprise one or more stabilizers or inhibitors to prevent undesired spontaneous polymerisation, like for example the commercially available Irganox® (Ciba Speciality Chemicals, Basel, Switzerland).

The curing time depends, inter alia, on the reactivity of the polymerisable material, the thickness of the coated layer, the type of polymerisation initiator and the power of the UV lamp. The curing time is preferably ≦5 minutes, very preferably ≦3 minutes, most preferably ≦1 minute. For mass production short curing times of ≦30 seconds are preferred.

Preferably polymerisation is carried out in an inert gas atmosphere like nitrogen or argon.

The polymerisable material may also comprise one or more dyes having an absorption maximum adjusted to the wavelength of the radiation used for polymerisation, in particular UV dyes like e.g. 4,4″-azoxy anisole or Tinuvin® dyes (from Ciba Speciality Chemicals).

The addition of one or more resins into the polymerisable material, transfer layer or the LC film to assist in the transfer process is beneficial for the transfer process. The resin preferably is not included in the polymer matrix and remains free to facilitate the transfer of the LC polymer when heated. Synthetic resins are preferred. Resins may at least include the following classes: aldehyde resins, ketone resins, (meth)acrylic resins, (meth)acrylic co-polymers and co-polymers of PVC or PVA. Aldehyde resins, like isobutyraldehyde-formaldehyde-urea resins, are especially suited. Among the many known resins thermoplastic resins are preferred, since they can make the transfer layer more susceptible to heat. Among resins named by their general function, tackifying and plasticizing resins are preferred. Suitable resins preferably have a softening point or a glass transition temperature. The softening temperature preferably is below 150° C. and very preferably below 100° C. The glass transition temperature is preferably below 100° C. and very preferably below 70° C. Softening points are usually defined according to DIN 53180 and glass transition temperatures are measured by DSC. The amount of resin is preferably 1-15%, more preferably 3-8% in the polymerisable material.

In another preferred embodiment the polymerisable material comprises one or more monoreactive polymerisable non-mesogenic compounds, preferably in an amount of 0 to 50%, very preferably 0 to 20%. Typical examples are alkylacrylates or alkylmethacrylates.

In another preferred embodiment the polymerisable material comprises one or more di- or multireactive polymerisable non-mesogenic compounds, preferably in an amount of 0 to 80%, very preferably 0 to 50%, most preferably 5 to 20%, alternatively or in addition to the di- or multireactive polymerisable mesogenic compounds. Typical examples of direactive non-mesogenic compounds are alkyldiacrylates or alkyldimethacrylates with alkyl groups of 1 to 20 C atoms. Typical examples of multireactive non-mesogenic compounds are trimethylpropanetrimethacrylate or pentaerythritoltetraacrylate. With compounds of this class less of the di- or multireactive polymerisable mesogens is needed and more of the monoreactive mesogens is added to the compositions. All ranges given in the further context of the application are adapted to the case where no non-mesogenic polymerisable compound is added.

It is also possible to add one or more chain transfer agents to the polymerisable material in order to modify the physical properties of the polymer film. Especially preferred are thiol compounds, for example monofunctional thiols like dodecane thiol or multifunctional thiols like trimethylpropane tri(3-mercaptopropionate). Very preferred are mesogenic or LC thiols as disclosed for example in WO 96/12209, WO 96/25470 or U.S. Pat. No. 6,420,001. By using chain transfer agents the length of the free polymer chains and/or the length of the polymer chains between two crosslinks in the polymer film can be controlled. When the amount of the chain transfer agent is increased, the polymer chain length in the polymer film decreases.

The polymerisable material may also comprise a polymeric binder or one or more monomers capable of forming a polymeric binder, and/or one or more dispersion auxiliaries. Suitable binders and dispersion auxiliaries are disclosed for example in WO 96/02597. Preferably, however, the polymerisable material does not contain a binder or dispersion auxiliary.

The polymerisable material can additionally comprise one or more additional components like for example catalysts, sensitizers, stabilizers, inhibitors, chain-transfer agents, co-reacting monomers, surface-active compounds, lubricating agents, wetting agents, dispersing agents, hydrophobing agents, adhesive agents, flow improvers, defoaming agents, deaerators, diluents, reactive diluents, auxiliaries, colourants, dyes or pigments, expecially wetting agents, rheology modifiers and surfactants, mostly depending on the item to be marked.

The thickness of a polymer film according to the present invention is preferably from 0.1 to 20 micrometers (μm), very preferably from 0.2 to 10 micrometers, most preferably from 0.5 to 5 micrometers. For cholesteric films the preferred thickness is 2 to 5 micrometers. For nematic films the preferred thickness is 0.5 to 2 micrometers. For use as an alignment layer, thin films with a thickness of 0.05 to 1, preferably 0.1 to 0.4 micrometers are preferred.

The on-axis retardation (i.e. at 0° viewing angle) of a nematic polymer film according to the present invention is preferably from >0 to 400 nm, especially preferably from 100 nm to 250 nm.

It is also possible to add, for example, a quantity of up to 20% by weight of a non polymerisable liquid-crystalline compound to adapt the optical properties of the resulting polymer film.

The polymer film of the present invention can also be used as an alignment layer for LC materials. For example, it can be used in an LC display to induce or improve alignment of the switchable LC medium, or to align a subsequent layer of polymerisable LC material coated thereon. In this way, stacks of polymerized LC films can be prepared.

In particular, the chiral compounds, mixtures, polymers and polymer films according to the present invention can be used in reflective polarizers as disclosed in GB 2 315 072 or WO 97/35219, alignment layers as disclosed in EP 1 376 163, birefringent markings or images for decorative or security use as disclosed in GB 2315760, WO 02/85642, EP 1295929 or EP 1381022.

The optically variable marking according to the present invention is especially suitable for use in security markings or security threads to authenticate, verify or prevent counterfeiting of objects like data carriers or documents of value, and for generation of hidden images, information or patterns on such objects. It can be directly applied onto said objects for verification or prevention of counterfeiting. Alternatively it can be applied onto an object, such as a data carrier or document of value, comprising additional data and/or information applied to the object for example in the form of an information indicating layer, a hologram, watermark, embossed or imprinted pattern or design, or the like. The marking can be applied onto said object such that it partially or completely covers the additional data and/or information, or may be applied onto a portion or region of said object not containing the additional data and/or information.

The optically variable marking according to the present invention can be applied to consumer products or household objects, car bodies, foils, packing materials, clothes or woven fabric, incorporated into plastic, or applied as security markings or threads on documents of value like banknotes, credit cards or ID cards, national ID documents, licenses or any product with money value, like stamps, tickets, shares, cheques etc.

Due to its different effects when viewed in transmission and reflection, the marking according to the present invention is especially suitable for the above described purposes on objects that are light transmissive, especially for visible light, or on light transmissive parts of said objects.

Suitable lasers used for the process generally have a wavelength in the range from 157 nm to 10.6 pm, preferably in the range from 532 nm to 10.6 μm. Mention may be made here by way of example of CO₂ lasers (10.6 μm) and Nd:YAG and Nd:YVO4 lasers (1064 and 532 nm respectively) or pulsed UV lasers. The excimer lasers have the following wavelengths: F₂ excimer laser (157 nm), ArF excimer laser (193 nm), KrCl excimer laser (222 nm), KrF excimer laser (248 nm), XeCl excimer laser (308 nm), XeF excimer laser (351 nm). Frequency-multiplied Nd:YAG lasers have wavelengths of 355 nm (frequency-tripled) or 265 nm (frequency-quadrupled). Particular preference is given to the use of Nd:YAG and YvO₄ lasers (1064 and 532 nm respectively) and CO₂ lasers. Using pulsed lasers, the pulse frequency is generally in the range from 1 to 100 kHz. Corresponding lasers which can be employed in the process according to the invention are commercially available.

Preference is given to the use of a Nd:YAG laser, Nd:YVO₄ laser or CO₂ laser in various laser wavelengths, 1064 nm or 808-980 nm. The marking process is possible in both continuous and pulsed operation. The suitable power of the laser preferably ranges from 2 to 100 W, and the pulse frequency typically is in the range from 1 to 200 kHz.

In the foregoing and the following, all temperatures are given in degrees Celsius, and all percentages are by weight, unless stated otherwise.

The examples below shall illustrate the invention without limiting it.

The following compounds defined below are used in the examples:

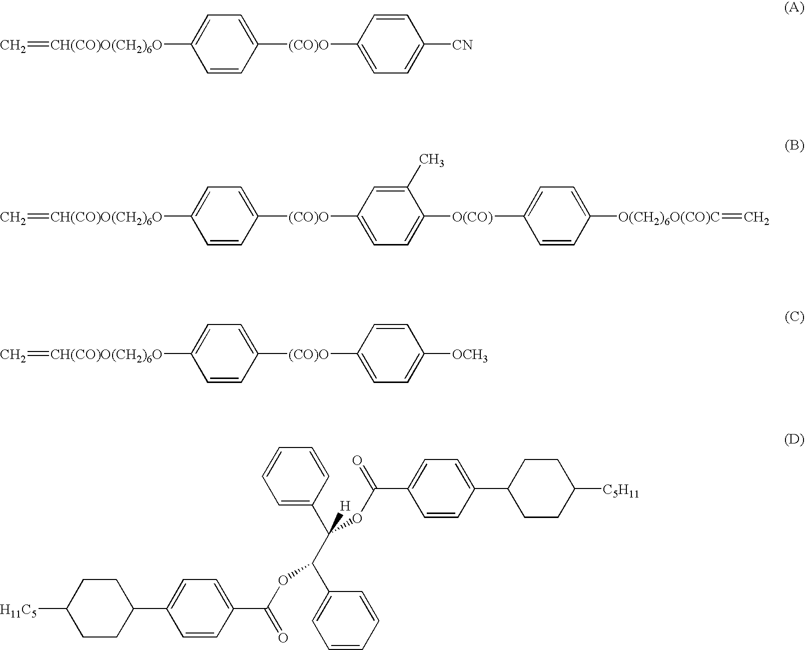

The polymerisable mesogenic compounds (A), (B) and (C) can be prepared according to or in analogy to the methods described in D. J. Broer et al., Makromol. Chem. 190, 3201-3215(1989).

The chiral dopant (D) can be prepared as laid down in the document GB 2328207.

Laropal® A81, a condensation product from urea and aliphatic aldehydes, is a commercially available aldehyde resin (BASF AG).

Irgacure® 651 is 2,2-Dimethoxy-1,2-diphenylethan-1-one, a commercially available photoinitiator (Ciba Specialty Chemicals).

Irganox® 1076 is (Octadecyl-3,5)-di-tert-butyl-4-hydroxyhydrocinnamate, a commercially available stabilizing agent (Ciba Specialty Chemicals).

Ethyl acetate is used as an inert solvent.

The laser equipment has a diode-pumped Nd:YAG laser with 1064 nm wavelength and a pulse frequency of 0-100 kHz. Maximum output power is 12 W, which can be regulated in a wide range of percentages. The beam has an intensity of about 1.5 GW/cm² at 20 kHz and a pulse length of 20 ns. The diameter of the beam is about 50 μm. The speed of the laser is set at up to 5 m·s⁻¹, preferably at 1-2 m·s⁻¹. Equipment of this kind together with computer-aided modulation of the beam is commercially available from a range of providers.

### EXAMPLE 1

The following polymerisable cholesteric liquid crystal (CLC) mixture is prepared:

| | |
|---|---|
| Compound (A) | 7.48% |
| Compound (B) | 30.00% |
| Compound (C) | 7.48% |
| Compound (D) | 2.50% |
| Laropal ® A81 | 2.00% |
| Irgacure ® 651 | 0.50% |
| Irganox ® 1076 | 0.04% |
| Ethyl acetate | 50.00% |

This solution is then applied by bar coating onto a black polyethylene substrate of about 50 micrometers thickness at a coating thickness of 12 μm. The coating is left at room temperature and the residual solvent allowed to evaporate. The remaining liquid crystalline film is then exposed to UV radiation in the absence of oxygen to leave a solid polymer film.

A sample of this film is then placed upon a black polypropylene tile as a receiving surface with the liquid crystal polymer layer sandwiched between the two plastic layers. The laser light (Nd:YAG laser) is directed at the film with an intensity of 90% and a pass speed of 1.5 m·s⁻¹. Absorption of the energy is sufficient to effect a transfer of the liquid crystal polymer film only at the sites where the laser is directed. The final device has an optically variable liquid crystal polymer layer in an individualized design. Furthermore viewing this device through the correct circular polariser (dependent upon the chirality of the cholesteric material used) will make the liquid crystal polymer film invisible.

### EXAMPLE 2

The following polymerisable nematic liquid crystal mixture is prepared:

| | |
|---|---|
| Compound (A) | 8.73% |
| Compound (B) | 30.00% |
| Compound (C) | 8.73% |
| Laropal ® A81 | 2.00% |
| Irgacure ® 651 | 0.50% |
| Irganox ® 1076 | 0.04% |
| Ethyl acetate | 50.00% |

This solution is then applied by bar coating onto a black polyethylene substrate of about 50 micrometers thickness at a coating thickness of 4 μm. The coating is left at room temperature and the residual solvent allowed to evaporate. The remaining liquid crystalline film is then exposed to UV radiation in the absence of oxygen to leave a solid polymer film.

A sample of this film is then placed upon a metallic or reflective foil with the liquid crystal polymer layer touching the metallic foil. The laser light (Nd:YAG laser) is directed at the film with an intensity of 90% and a pass speed of 1.5 m·s⁻¹. Absorption of the energy is sufficient to effect a transfer of the liquid crystal polymer film only at the sites where the laser is directed. Viewing the metallic foil through a circular polariser makes the marked areas with the nematic transfer clearly visible against a darker background where no marking is present.

1. A transfer process for forming a marking on a surface comprising the steps of
a) providing a transfer element comprising a light-to-heat conversion layer and a transfer layer comprising a liquid crystal material,
b) placing the transfer element onto a receiving surface with the transfer layer directed to the surface
c) irradiating the assembly selectively with a radiation source in a manner effective to transfer portions of the transfer layer corresponding to the irradiated areas onto the surface.

2. Process according to claim 1 wherein the radiation source is a laser beam.

3. Process according to claim 1 wherein the liquid crystal material comprised in the transfer layer comprises a cross-linked liquid crystal material.

4. Process according to claim 1 wherein the transfer layer additionally comprises a resin.

5. Process according to claim 1 wherein the resin is a thermoplastic resin.

6. Process according to claim 1 wherein the transfer layer is prepared by spreading a composition comprising
one or more polymerisable mesogens,
a resin, and
a polymerisation initiator
onto a substrate and polymerising it.

7. A thermal transfer element comprising at least
a light-to-heat conversion layer, and
a transfer layer, comprising at least a liquid crystal material.

8. A transfer element according to claim 7 wherein the transfer layer comprises 1-15% of one or more resins.

9. A transfer element according to claim 7,
wherein the thermal transfer layer comprises at least 30% of one or more cross-linked liquid crystalline components.

10. A transfer element according to claim 7,
wherein the light-to-heat conversion layer is a radiation absorbing polymeric substrate or a non-reflecting metal foil.

11. Composition for forming a liquid crystalline thermal transfer layer comprising at least
one or more polymerisable mesogens,
a resin, and
a polymerisation initiator.

12. Polymeric liquid crystalline marking on a surface formed by a process according to claim 1.

13. Use of a polymeric liquid crystalline marking formed by a process according to claim 1 for security applications, identification, labelling, counterfeit prevention or decoration.

14. A data carrier or document of value comprising a marking according to claim 12.
